(19) United States
(12) Patent Application Publication
(10) Pub. No.: US 2026/0142051 A1
(43) Pub. Date: May 21, 2026

(54) Multi-tool General Coupling System and Handling Method for Treating Radioactive Package

(71) Applicants: China National Nuclear Corporation Sichuan Environmental Protection Engineering Co., Ltd., Guangyuan (CN); Nusim S.A.U., Sevilla (ES); NEPTU International Co., Ltd., Shanghai (CN)

(72) Inventors: Wei ZHANG, Guangyuan (CN); Tianxin AN, Guangyuan (CN); Francisco Bernal Martínez, Guangyuan (CN); Wei WANG, Guangyuan (CN); Hao FAN, Guangyuan (CN); Ya ZHOU, Guangyuan (CN); Nicasio García Muelas, Guangyuan (CN); Manuel García Gomez, Guangyuan (CN); Xiangbao ZENG, Guangyuan (CN); Jingqian LIU, Guangyuan (CN); Juan José Aragon Lozano, Guangyuan (CN); Jun LI, Guangyuan (CN); Han ZHAO, Guangyuan (CN); Tao YANG, Guangyuan (CN); Shuaizhen WU, Guangyuan (CN); Kunlin MU, Guangyuan (CN); Hexin SUN, Guangyuan (CN)

(21) Appl. No.: 19/006,944

(22) Filed: Dec. 31, 2024

(30) Foreign Application Priority Data
Nov. 20, 2024 (CN) 2024116603271

(51) Int. Cl. G21F 5/14; G21F 7/06

(52) U.S. Cl. CPC G21F 5/14; G21F 7/065; G21F 7/066

(57) ABSTRACT

The present invention relates to the technical field of the nuclear industry, and in particular to a multi-tool general coupling system and a handling method for treating a radioactive package. The system includes a main clamp, including a claw disc and a clamping finger; and an auxiliary clamp, including clamps and interfaces, where when the main clamp cannot complete the specific operation, the matched clamping finger is coupled to each interface to execute the specific operation, ensuring that a bucket container is safely hoisted and released. And through the quick connection of the main clamp and the auxiliary clamp, safe transfer is achieved and the replacement time is reduced.

### CROSS-REFERENCE TO RELATED APPLICATIONS

The present application claims priority to Chinese Patent Application No. 2024116603271, filed on Nov. 20, 2024, the entire disclosure of which is incorporated herein by reference.

### TECHNICAL FIELD

The present invention relates to the technical field of the nuclear industry, and in particular to a multi-tool general coupling system and a handling method for treating a radioactive package.

### BACKGROUND

Safely treating a radioactive package is not only related to safely transporting a nuclear material, but also related to preventing nuclear proliferation and protecting environment and public health. A correct treatment program can ensure a minimum risk of a radioactive material in the process of production, use, storage, and transportation, and can avoid potential radiation hazards to humans and the environment. Therefore, properly treating the radioactive package is the key to safe use and sustainable development of nuclear energy.

In the prior art, there are usually two solutions to treat various types of radioactive packages:

First, it needs a separate workspace for each type of packages in a facility treating various types of packages; this requires a separate storage area for each type of packages: one for a bucket, another for a metal container, and yet another for a concrete container, a handling rectangular container, a handling container lid, etc.; and once the packages are separated, there is a need for each storage area being equipped with a specific handling tool adapting to the package that it is intended to treat.

Second, as an alternative solution using an isolated storage area, the only other selection is to replace treating equipment each time different types of packages are needed to be treated; however, an operation method of replacing a handling tool is complicated; radioactive package treatment equipment is robot and remotely operated, which will also involve a large number of connections and a strict verification program before the operation; and in addition, the equipment has been operating in a radioactive environment since then, and all these operations related to tool changes require an operator to enter and work in an exposed area to be radiated.

So, the previous technology has the main disadvantage that it is impossible to use a crane to use various types of packages in one storage area: each type of packages requires special work space and treating tools, which limits flexibility of the operation; and if there is no long-time direct operator, it is impossible to replace an operating tool.

Therefore, a multi-tool general coupling system and a handling method for treating a radioactive package is provided.

### SUMMARY

In view of the prior art, treating different radioactive packages further requires arranging different working areas separately or in a single storage area, which requires to replace different treating equipment with a complicated replacement, thereby leading to a problem that an operator needs to enter a radiation area. Therefore, a multi-tool general coupling system for treating a radioactive package is provided.

In order to solve the above technical problem, the present invention provides the following technical solution: a multi-tool general coupling system for treating a radioactive package includes a main clamp, including a claw disc and a clamping finger arranged on the claw disc; and an auxiliary clamp, including various clamps corresponding to handling different goods or executing specific operations, and interfaces arranged on the clamps and being in coupling matching with the clamping finger, where when the main clamp cannot complete the specific operation, the matched clamp is selected, and the clamping finger is coupled to each interface to execute the specific operation by using the clamp.

As a preferred solution of the multi-tool general coupling system for treating the radioactive package of the present invention, the interface includes a guide portion shrinking from top to bottom and an accommodating portion communicating with the guide portion; and the clamping finger enters the accommodating portion after passing through the guide portion.

As a preferred solution of the multi-tool general coupling system for treating the radioactive package of the present invention, an accommodating space is formed inside the clamping finger; a wedge is rotatably connected to an interior of the accommodating space; when the wedge rotates out of the accommodating space, a gripping state is formed; and the accommodating space is further provided with a control portion connected to the wedge inside, and the control portion is used for a folding action of the wedge without participating to a gripping work.

As a preferred solution of the multi-tool general coupling system for treating the radioactive package of the present invention, a wedge rotating shaft is arranged at one end of the wedge, and is movably connected to the accommodating space through a rotating shaft.

As a preferred solution of the multi-tool general coupling system for treating the radioactive package of the present invention, the control portion is driven by an electromagnet, the accommodating space is slidably provided with an electromagnetic transmission rod inside, and a fork rod is movably arranged at one end of the electromagnetic transmission rod; and the fork rod is provided with a rod connecting shaft.

As a preferred solution of the multi-tool general coupling system for treating the radioactive package of the present invention, the wedge is provided with a wedge connecting rod; and a wedge rotating rod is rotatably arranged between the rod connecting shaft and the wedge connecting rod.

As a preferred solution of the multi-tool general coupling system for treating the radioactive package of the present invention, a connecting block is arranged on an outer wall of the clamping finger, and is externally provided with a detector; and a spring is arranged between the detector and the connecting block.

As a preferred solution of the multi-tool general coupling system for treating the radioactive package of the present invention, a notch is formed in the guide portion, and provided with a plane; and the plane is movably matched with the detector.

As a preferred solution of the multi-tool general coupling system for treating the radioactive package of the present invention, the accommodating portion is provided with a matching block inside; and there is at least one surface capable of accommodating contact force of the wedge on the matching block.

In view of the problems mentioned above, a handling method for treating a radioactive package of the present invention is provided.

In order to solve the above technical problems, the present invention provides the following technical solution: a handling method for treating a radioactive package includes: the multi-tool general coupling system for treating the radioactive package; and identifying to-be-handled radioactive goods, including, but not limited to, a radioactive bucket, a concrete container, a rectangular container, a container cover, a mobile storage stabilizing plate, a storage unit, etc.; confirming use of main clamp handling or auxiliary clamp handling according to a type of goods; moving, if there is a need for the auxiliary clamp executing an operation, the main clamp to a position above the auxiliary clamp, enabling the clamping finger to align to and enter the guide portion and the accommodating portion in sequence, and enabling the wedge to make a contact to and be matched with the matching block to connect the main clamp with the auxiliary clamp; and executing a handling task to convey the goods to a designated position after the connection of the auxiliary clamp.

The present invention has the beneficial effects that: by arranging the main and auxiliary clamps, the main clamp is fixed on a crane to be used for handling different goods, and adapts to the most common single storage package, that is, a cylindrical metal bucket. The main clamp does not need power to start and maintain clamping in treating a radioactive bucket, which prevents an accidental bucket release in mid-air or due to improper support, thereby improving safety performance during handling. On this basis, when the system needs to handle other goods or execute a specific operation that the main clamp cannot complete, such as handling the rectangular container, the concrete container, and the container lid, moving the storage stabilizing plate, unlocking the storage unit, etc., it is achieved by using one general head without manually replacing the tool. The general head can be attached with required tools as needed. By attaching various tools to the main clamp, the wedge is connected to the matching block to change basic functions, thereby treating from the bucket to any other type of packages or executing a complicated treating operation.

### BRIEF DESCRIPTION OF DRAWINGS

To more clearly describe the technical solutions of the embodiments of the present invention, the accompanying drawings required to describe the embodiments are briefly described below. Apparently, the accompanying drawings described below are only some embodiments of the present invention. Those skilled in the art may further obtain other drawings based on these accompanying drawings without inventive effort. In the drawings:

FIG. 1 is a schematic diagram of a connection structure of a main clamp and an auxiliary clamp of the present invention;

FIG. 2 is a cross-section view of a connection structure of an interface of the present invention;

FIG. 3 is a schematic diagram of a connection structure of a notch of the present invention;

FIG. 4 is a schematic diagram of a connection structure of a claw disc and a clamping finger of the present invention;

FIG. 5 is a cross-section view of an interior structure of a clamping finger of the present invention; and

FIG. 6 is an enlarged schematic diagram of a connection structure of a wedge of the present invention.

### DETAILED DESCRIPTION OF THE EMBODIMENTS

To make the described objectives, features and advantages of the present invention more obvious and more understandable, the specific embodiments of the present invention are described in detail below in conjunction with the accompanying drawings.

A number of specific details are set forth in the description below to provide a thorough understanding for the present invention, however, the present invention may also be implemented in other manners different from those described herein, and those skilled in the art may make similar generalization without departing from the essence of the present invention; therefore, the present invention is not limited by the specific embodiments disclosed below.

Secondly, “one embodiment” or “embodiment” referred to herein refers to a specific feature, structure, or characteristic that may be included in at least one implementation manner of the present invention. The “in one embodiment” appearing in different parts of the present specification does not necessarily refer to the same embodiment, nor a separate or selective embodiment that is mutually exclusive to other embodiments.

Thirdly, the present invention is described in detail in conjunction with illustrations. When the embodiments of the present invention are described in detail, for ease of description, sectional views of the device structures are partially enlarged without being drawn to scale. The illustrations are merely exemplary and should not limit the protection scope of the present invention. Furthermore, it is important to consider the three-dimensional spatial dimensions of length, width, and depth in actual production.

### Embodiment 1

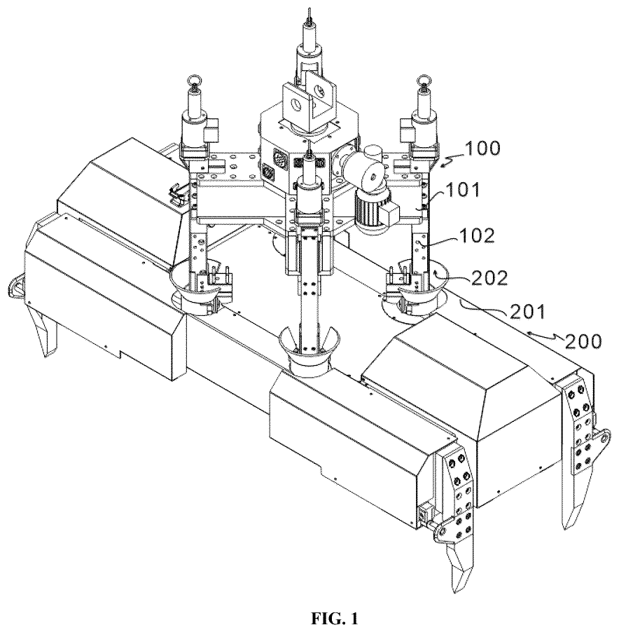

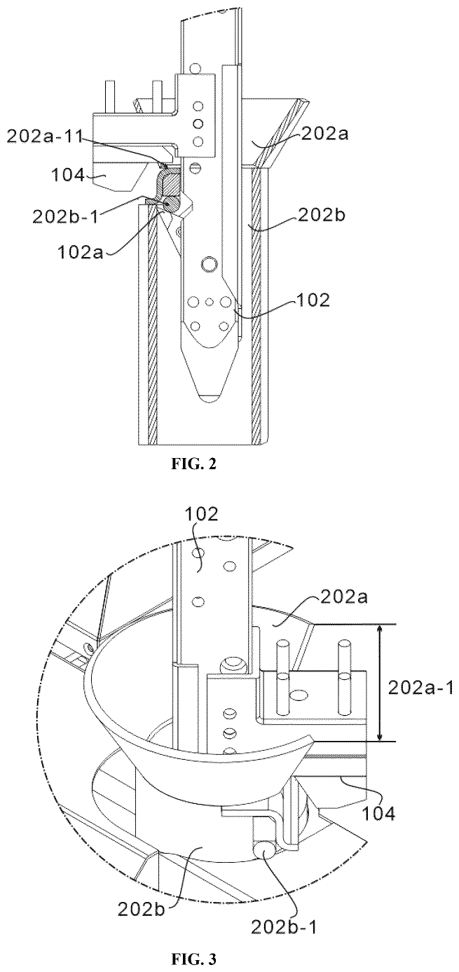

Referring to FIGS. 1-3, showing a first embodiment of the present invention, the embodiment provides a multi-tool general coupling system for treating a radioactive package, including a main clamp 100, including a claw disc 101 and a clamping finger 102 arranged on the claw disc 101; and an auxiliary clamp 200, including various clamps 201 corresponding to handling different goods or executing specific operations, and interfaces 202 arranged on the clamps 201 and being in coupling matching with the clamping finger 102, where when the main clamp 100 cannot complete the specific operation, the matched clamp 201 is selected, and the clamping finger 102 is coupled to each interface 202 to execute the specific operation by using the clamp 201.

The auxiliary clamp 200 does not singly refer to a certain clamp, but refers to various clamps that adapt to different specific handling operations. As shown in FIG. 1, the auxiliary clamp 200 shows one of clamps for clamping a rectangular container.

The main clamp 100 adapts to a single storage unit. All radioactive waste storage facilities are cylindrical buckets. The main clamp 100 is usually suspended on a bridge crane covering treatment, storage and/or scheduling areas.

The claw disc 101 can be equipped with three or four clamping fingers 102, depending on whether equipment is used for positioning a bucket in a triangular or orthogonal configuration; there are 3 or 4 clamp fingers 102, which provides an internal redundancy, a failure of one point will not cause the buckets to fall off, and the bucket can still be grasped by the remaining points; regardless of a weight of the bucket, it can be safely clamped; moreover, the four fingers 102 can be extended or retracted at the same time, so as to adapt to gripping different sizes of containers.

By fixing the main clamp 100, the main clamp 100 is connected to the crane. The main clamp 100 cannot only safely treat the radioactive bucket container, but also quickly and automatically be equipped with accessories to minimize operator's intervention, thereby allowing development of a new operation incompatible with the main clamp. Therefore, in addition to treating the bucket, it is possible to treat a container, close the bucket or the container, place stabilizing plates between different layers of stacked packages, and even execute sealing with concrete or gap filling with gravel, without replacing a main matrix tool of the bridge crane operating in a radioactive waste storage facility.

By treating various sizes of buckets and containers in a storage facility for treating the radioactive package, they are nested in other buckets or containers, or in larger containers. The containers are opened and closed, the packages are stacked together, and a program of filling gaps or eventually sealing the packages is executed. All of these operations require a plurality of tools that are suspended on an automated bridge crane and are needed to be remotely operated in a control room. Replacing a complicated robot tool integrating a plurality of connections is laborious, risky, and slow. In addition, each of these replacements in a radioactive environment will expose the operator to radiation for a long time. Therefore, in order to solve this problem, by the clamping finger 102 being coupled to the interface 202, the main clamp 100 and the auxiliary clamp 200 are connected in a matching way, and the corresponding matched clamp is selected to shorten a radiation contact time of the operator replacing the tool.

To sum up, this arrangement allows use of a single main clamp 100 as a fixed treating element in one storage facility to treat various types of packages, and it eliminates the need that the operator executes a tedious task in a radiation exposure area to replace a treating configuration of the bridge crane, so that treating different types of packages does not need to work in batches, thereby allowing direct use of the bridge crane to execute a package treating task without moving the package to a specific workstation.

### Embodiment 2

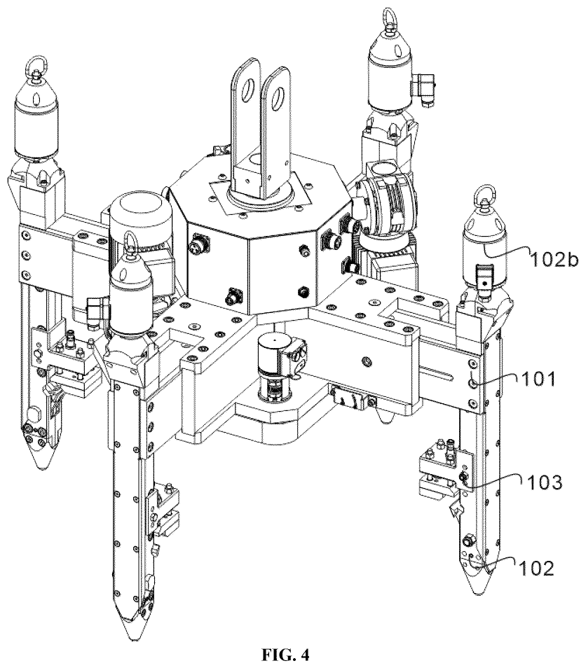

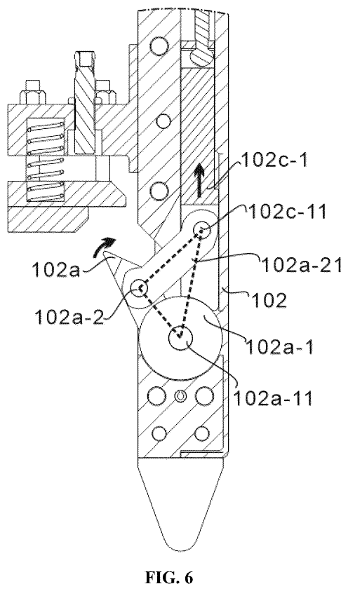

Referring to FIGS. 1-6, showing a second embodiment of the present invention, the embodiment is different from the previous embodiment in that the interface 202 includes a guide portion 202a shrinking from top to bottom and an accommodating portion 202b communicating with the guide portion 202a; and the clamping finger 102 enters the accommodating portion 202b after passing through the guide portion 202a.

The guide portion 202a is preferably arranged in a conical shape. Due to a top-down shrinking design, it is convenient to position the clamping finger when the clamping finger 102 is connected to the interface 202, so that the clamping finger can align to and enter the accommodating portion 202b.

The accommodating portion 202b is preferably in a bucket shape, and has a certain space inside, allowing the clamping finger 102 to enter.

Preferably, an accommodating space K is formed inside the clamping finger 102; a wedge 102a is rotatably connected to an interior of the accommodating space K; when the wedge 102a rotates out of the accommodating space K, a gripping state is formed; and the accommodating space K is further provided with a control portion 102b connected to the wedge 102a inside, and the control portion 102b is used for a folding action of the wedge 102a without participating to a gripping work.

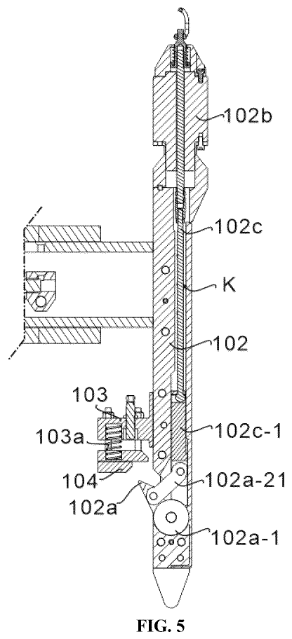

Unfolding the wedge 102a occurs automatically without a foldable command. A final unfolding position of the wedge 102a is limited by a stroke of a fork rod 102c-1. When the wedge makes a contact to a wedge rotating shaft 102a-1, as shown in FIG. 5, the contact at this point limits and prevents a maximum drop of the fork rod 102c-1.

Preferably, the wedge rotating shaft 102a-1 is arranged at one end of the wedge 102a, and is movably connected to the accommodating space K through a rotating shaft 102a-11.

Preferably, the control portion 102b is driven by an electromagnet, the accommodating space K is slidably provided with an electromagnetic transmission rod 102c inside, and the fork rod 102c-1 is movably arranged at one end of the electromagnetic transmission rod 102c; and the fork rod 102c-1 is provided with a rod connecting shaft 102c-11.

As shown in FIG. 5, the control portion 102 used is the electromagnet, which is composed of a housing with a coil and a weighted iron core. In addition, the control portion further includes a vertical preload spring, which increases a weight of the iron core and keeps it in a static position. When the system is not energized, the iron core is supported by gravity, and is pushed onto a drive system by the preloaded spring through the electromagnetic transmission rod 102c to support its weight. Therefore, in a resting state, the wedge 102a is placed in an open clamping position. If the wedge 102a is to be folded, it is necessary to activate the electromagnet. After power supply, the iron core of the electromagnet is attracted by the coil and rises, and then is pulled to move upward through the electromagnetic transmission rod 102c. This upward movement makes the fork rod 102c-1 move, which activates the wedge rotating rod 102a-21 and the wedge connecting rod 102a-2. Therefore, the wedge rotating rod 102a-21 makes the wedge 102a rotate around its wedge rotating shaft 102a-11, and folds it into the internal accommodating space K of a structural body of the clamping finger 102. In this folding position, the wedge 102a no longer interferes with the bucket mechanically, allowing the wedge 102a to be lifted without lifting the bucket.

Unfolding the wedge 102a automatically occurs without the folding command. Therefore, if there is no signal and no voltage applied, a resting position of the wedge 102a is the unfolding position, that is, a position of clamping the bucket.

Preferably, the wedge 102a is provided with the wedge connecting rod 102a-2; and the wedge rotating rod 102a-21 is rotatably arranged between the rod connecting shaft 102c-11 and the wedge connecting rod 102a-2.

If the bucket is to be clamped, the main clamp 100 is directly placed right above the bucket and aligns to a bridge crane suspending it. After positioning, a crane bridge descends to make the clamping finger 102 closer to the bucket. When the clamping finger 102 makes a contact to the bucket, due to a geometric shape design of the wedge 102a, it uses a chamfer integrated at a center tip of the wedge 102a for self-centralization. Once the clamping finger is centered, it is continued to descend until a detector 104 makes a contact to the bucket and confirms this position by sending a signal to a control system. During descending, there is no need for activating the electromagnet to retract a claw. As the claw descends, after the bucket passes, the wedge 102a automatically returns to the unfolding position due to a vertical thrust of the electromagnet.

When a container is suspended by the wedge 102a, its weight acts on the unfolded wedge 102a due to interference between an edge of the container and the claw. A load of the container is transmitted through the wedge connecting rod 102a-2. Since the rod connecting shaft 102c-11 has only freedom of vertical movement and the rotating shaft 102a-11 has no freedom of movement, the container is completely locked to ensure its suspension load. The suspension load is transmitted to the clamping finger 102 by all the force, which means that the load is suspended indefinitely due to mechanical interference without any energy input.

The clamping finger 102 has an inherent safety redundancy; and even if the wedge rotating rod 102a-21 fails, it can maintain the suspension load. This is because in a case of a mechanism failure, the wedges 102a will be unfolded until they make a contact to a container body; the wedges 102a cannot be opened further because the container itself will prevent their further movement, thereby preventing the container from falling off without any additional element.

The clamping finger 102 ensures not to release the container when the container is suspended. In order to achieve this, the system integrates two redundant safety characteristics:

A first safety characteristic: retraction of the wedge 102a, activated by the electromagnet, will encounter resistance due to the weight of the container acting on the claw; if the claw is to be retracted, the electromagnet needs to lift the container, and a release mechanism of the electromagnet is designed so that its tension is limited and always smaller than force required for lifting a lightest configured container: empty and lidless containers; in fact, the tension of the electromagnet is calibrated to be as close as possible to a minimum value required for operating an entire transmission mechanism in a load-free state without any external load, which means that it is adjusted to lift only the iron core of the electromagnet, compress the vertical preload spring, and support a weight of elements that form a drive kinematic chain; and therefore, it cannot operate mechanisms of the wedge connecting rod 102a-2 and the wedge rotating rod 102a-21 while supporting the weight of the bucket.

A second safety characteristic: even if the electromagnet mechanism has enough force to lift the container, if the edge of the container snaps between the wedge 102a and the clamping finger 102, movement of the wedge 102a will be blocked by interference.

Preferably, a connecting block 103 is arranged on an outer wall of the clamping finger 102, and is externally provided with a detector 104; and a spring 103a is arranged between the detector 104 and the connecting block 103.

The container can be released only after the container is placed on the ground and a gripper is stabilized on the detector 104 on the container. By placing and supporting the detector 104 on the container, this ensures that there is an enough edge between the container and the detector for separating the wedge 102a from the container, and allows the folding mechanism to be freely activated and folded.

Through this arrangement, if it is simple to control opening and closing of the clamping finger 102 respectively, each time the clamping finger falls on the radioactive bucket, it will alternate between opening and closing. If a support is placed on an incorrect surface improperly, or the bucket makes an accidental contact to another bucket during descending, the gripper will be automatically opened if the operator cannot prevent the above situation, resulting in radioactive bucket falling and a reportable accident. Therefore, through this arrangement, the following problems can be avoided: first, due to an operator's error or a control system failure, the bucket may be released by the gripper in the mid-air; second, if an incorrect release position is detected or an accident is foreseen, the bucket will be automatically released without giving the operator an option to cancel the operation; and third, power is needed to maintain clamping of the bucket, so if power supply fails, the bucket will fall off.

Through this arrangement, clamping and suspension of the bucket can be maintained without any power supply; the bucket can be clamped without any action or power input; and a voluntary command is required for releasing the bucket, so that an accidental release of the bucket in the mid-air or due to improper support is prevented; a clamping time is shortened; sealed and unsealed buckets are safely clamped regardless of the weights of the buckets. Due to interference between the wedge 102a and a bucket's ring or a curl of a bucket's upper edge, the bucket is prevented from falling off in the mid-air.

The main clamp 100 in this design includes detection systems that notify the operator of states of various safety elements affecting operation safety.

Through its inherently designed safety, it is mechanically impossible to activate the release in load suspension or clamping. The force of the release mechanism is calibrated to prevent activation when the load is not completely free, and the clamping mechanism maintains mechanical interference with the bucket until the bucket is properly supported on the ground. The system developed can safely clamp the bucket regardless of the sealed or unsealed bucket, because the claw system adapts to a tiny diameter change between lidded and unlidded buckets. The clamping system is designed for adapting to a lip of an upper edge of an opened bucket or an edge of the sealed bucket. In addition, the system ensures to safely clamp the bucket regardless of its weight, because the system does not depend on the weight of the bucket to generate the clamping force. This versatility is crucial, especially in treating a lightweight bucket. The system that generates the clamping force depending on the weight may be unsafe, and is prone to losing clamping due to a slight impact during treatment, which may lead to falling off.

### Embodiment 3

Referring to FIGS. 1-6, showing a third embodiment of the present invention, the embodiment is different from the previous embodiment in that a notch 202a-1 is formed in the guide portion 202a, and provided with a plane 202a-11; and the plane 202a-11 is movably matched with the detector 104.

Arranging the notch 202a-1 can facilitate placement of the detector 104, the plane 202a-11 can also be obtained through the notch 202a-1, and thus a position sensor can be used to confirm a role of a gripping tool in reaching a correct gripping state and position.

Preferably, the accommodating portion 202b is provided with a matching block 202b-1 inside; and there is at least one surface capable of accommodating contact force of the wedge 102a on the matching block 202b-1.

The matching block 202b-1 is preferably a cylindrical strip, which is convenient for processing and also simulates a shape of the edge of the bucket.

Mechanically coupling the main clamp 100 to the auxiliary clamp 200 is mainly connection between the clamping finger 102 and the interface 202, which is similar to the process of clamping the bucket. After the clamping finger 102 enters the accommodating portion 202b, there is no need for running the control portion 102b, the wedge 102a makes a contact to and is matched with the matching block 202b-1, and the wedge and the matching block are connected by folding and unfolding of the wedge.

Through this arrangement, the auxiliary clamp 200 is directly connected to the main clamp 100, which solves impossibility of using a single crane to treat various types of packages in one storage facility, solves impossibility of treating various types of packages without replacing a treating tool, solves impossibility of replacing the treating tool without involving the operator's direct intervention in a radiation exposure area for a long time, and solves impossibility of directly using the bridge crane to execute a package treating task without moving it to a specific workstation.

Various treating tools as auxiliary clamps 200 are designed so as to be grabbed by a clamping jaw for connection, and then be transformed into new tools with new functions, new sensors and new logics. The main clamp 100 can be attached to a new tool, requiring a structural interface to be integrated into the tool to replicate an upper geometric shape of the bucket. This interface necessarily has a structural capacity required by a load capacity required by the new tool, which will depend on a weight of a to-be-treated package. Mechanical coupling also necessarily considers inherent safety functions of the clamping jaw to ensure that they are not offset. The clamping jaw and the tool necessarily retain the safety functions of the clamping jaw, and they are added to any other safety functions integrated into the tool. Once the tool is mechanically coupled to the clamping jaw, power and control connections are needed to safely control assembly in an operation control room for a nuclear facility. Whenever possible, priority should be given to fusion of control and command signals. Its goal is to keep the signals and commands in the control room, so that the signal that previously guides the clamping jaw now guides tool assembly. An objective of signal fusion is to avoid a need for modifying an HMI system in the control room. Due to current integration of PLC and use of network protocols to transmit information, signal reduction is not a priority. Physical assembly of power and control connectors can be performed automatically or manually. If related economic costs achieved by a radiation dose and reasonably proved are reduced, the operator can perform minimal and quick intervention.

Through the auxiliary clamp 200, remote attachment can be performed to operate assembly as new treating tools with new characteristics and functions, which have possibility of treating accessories being attached to main treating elements. The tools are designed to have interfaces similar to an opening of the bucket, allowing the wedge 102a to treat them like to treat the bucket. Each tool is designed to be seamlessly connected to the interface 202. Electrical and control connections are performed through a special connector that integrates with the overall system, so as to ensure minimal direct intervention of the operator. After mechanical coupling, the corresponding electrical connector is manually connected, which shortens an operation time of a worker replacing the clamp in the radiation area compared with the prior art.

Interference of the geometric shape and an ingenious mechanical design of the wedge 101a fix the load without relying on any kinematic chain, and ensures a passive grasping function without energy input during gripping to guarantee safety of the load, so that the wedge 101a can firmly grasp the bucket, providing safe gripping.

### Embodiment 4

Referring to FIGS. 1-6, showing a fourth embodiment of the present invention, the embodiment is different from the previous embodiment in that: the embodiment provides a handling method for treating a radioactive package.
identifying to-be-handled radioactive goods, including, but not limited to, a radioactive bucket, a concrete container, a rectangular container, a container cover, a mobile storage stabilizing plate, a storage unit, etc.;
confirming use of main clamp handling or auxiliary clamp handling according to a type of goods;
moving, if there is a need for the auxiliary clamp executing an operation, the main clamp to a position above the auxiliary clamp, enabling the clamping finger to align to and enter the guide portion and the accommodating portion in sequence, and enabling the wedge to make a contact to and be matched with the matching block to connect the main clamp with the auxiliary clamp; and
executing a handling task to convey the goods to a designated position after the connection of the auxiliary clamp.

To sum up, the main clamp 100 and the auxiliary clamp 200 are designed to adapt to radioactive objects in different shapes and sizes, so as to provide flexibility of the operation and ensure safe handling of various types of goods.

Importantly, it should be noted that the constructions and arrangements of the present application shown in a plurality of different exemplary implementation solutions are merely exemplary. Although only a few implementation solutions are described in detail in the contents disclosed herein, those having reference to the contents disclosed herein should readily understand that many modifications are possible (for example, variations in the sizes, dimensions, structures, shapes and proportions of various elements, parameter values (such as temperatures and pressures), installations and arrangements, use of materials, colors, orientations, etc.), without materially departing from the novel teachings and advantages of the subject described in the present application. For example, the elements shown as integrally formed may be constructed of a plurality of parts or elements, the positions of the elements may be inverted or varied in other manners, and the properties, quantities or positions of the discrete elements may be altered or varied. Therefore, all such modifications are intended to be included within the scope of the present invention. The order or sequence of any process or method steps may be changed or re-sequenced according to alternative embodiments. In the claims, any provision of “apparatus with function” is intended to cover the structure described herein for executing the function, and is not merely structurally equivalent but also equivalent in structure. Other substitutions, modifications, variations, and omissions may be made in the design, operation conditions, and arrangements of the exemplary implementation solutions without departing from the scope of the present invention. Therefore, the present invention is not limited to the specific implementation solutions but extends to a plurality of modifications still falling within the scope of the appended claims.

In addition, in order to provide a concise description for the exemplary implementation solutions, not all features of an actual implementation solution are described (that is, those features that are not relevant to the currently-considered optimal mode for executing the present invention, or those features that are not relevant to realizing the present invention).

It should be appreciated that lots of decisions on specific embodiments can be made during any actual practical development, for example, in any engineering or design project. Such development efforts may be complicated and time-consuming, but for those skilled in the art benefiting from the present invention, too many experiments are not necessary, and the development efforts will be a regular work of design, making and production.

It should be noted that, the above embodiments are merely used for illustrating the technical solution of the present invention and not to limit the technical solution, although the present invention has been described in detail with reference to the preferred embodiments, those of ordinary skill in the art should understand that, modifications or equivalent substitutions may be made on the technical solution of the present invention without departing from the spirit and scope of the technical solution of the present invention, and the modifications or equivalent substitutions should be incorporated into the scope of the claims of the present invention.

What is claimed is:

1. A multi-tool general coupling system for treating a radioactive package, comprising:
a main clamp, comprising a claw disc and a clamping finger arranged on the claw disc; and
an auxiliary clamp, comprising various clamps corresponding to handling different goods or executing specific operations, and interfaces arranged on the clamps and being in coupling matching with the clamping finger, wherein
when the main clamp cannot complete the specific operation, the matched clamp is selected, and the clamping finger is coupled to each interface to execute the specific operation by using the clamp.

2. The multi-tool general coupling system for treating the radioactive package according to claim 1, wherein the interface comprises a guide portion shrinking from top to bottom and an accommodating portion communicating with the guide portion; and the clamping finger enters the accommodating portion after passing through the guide portion.

3. The multi-tool general coupling system for treating the radioactive package according to claim 1, wherein an accommodating space is formed inside the clamping finger; a wedge is rotatably connected to an interior of the accommodating space; when the wedge rotates out of the accommodating space, a gripping state is formed; and
the accommodating space is further provided with a control portion connected to the wedge inside, and the control portion is used for a folding action of the wedge without participating to a gripping work.

4. The multi-tool general coupling system for treating the radioactive package according to claim 1, wherein a wedge rotating shaft is arranged at one end of the wedge, and is movably connected to the accommodating space through a rotating shaft.

5. The multi-tool general coupling system for treating the radioactive package according to claim 4, wherein the control portion is driven by an electromagnet, the accommodating space is slidably provided with an electromagnetic transmission rod inside, and a fork rod is movably arranged at one end of the electromagnetic transmission rod; and
the fork rod is provided with a rod connecting shaft.

6. The multi-tool general coupling system for treating the radioactive package according to claim 2, wherein the wedge is provided with a wedge connecting rod; and a wedge rotating rod is rotatably arranged between the rod connecting shaft and the wedge connecting rod.

7. The multi-tool general coupling system for treating the radioactive package according to claim 6, wherein a connecting block is arranged on an outer wall of the clamping finger, and is externally provided with a detector; and a spring is arranged between the detector and the connecting block.

8. The multi-tool general coupling system for treating the radioactive package according to claim 7, wherein a notch is formed in the guide portion, and provided with a plane; and the plane is movably matched with the detector.

9. The multi-tool general coupling system for treating the radioactive package according to claim 8, wherein the accommodating portion is provided with a matching block inside; and there is at least one surface capable of accommodating contact force of the wedge on the matching block.

10. A handling method for treating a radioactive package, comprising: the multi-tool general coupling system for the radioactive package according to claim 1; and
identifying to-be-handled radioactive goods, including, but not limited to, a radioactive bucket, a concrete container, a rectangular container, a container cover, a mobile storage stabilizing plate, a storage unit, etc.;
confirming use of main clamp handling or auxiliary clamp handling according to a type of goods;
moving, if there is a need for the auxiliary clamp executing an operation, the main clamp to a position above the auxiliary clamp, enabling the clamping finger to align to and enter the guide portion and the accommodating portion in sequence, and enabling the wedge to make a contact to and be matched with the matching block to connect the main clamp with the auxiliary clamp; and
executing a handling task to convey the goods to a designated position after the connection of the auxiliary clamp.
